(19) United States
(12) Patent Application Publication
(10) Pub. No.: US 2025/0377024 A1
(43) Pub. Date: Dec. 11, 2025

(54) STRUT BEARING DEVICE

(71) Applicant: AKTIEBOLAGET SKF, GOTEBORG (SE)

(72) Inventors: Paul RABOURDIN, Chambray lès Tours (FR); Romain MEDARIAN, Tours (FR); Jonathan REPESSE, Esvres sur Indre (FR); Thomas LEPINE, Tours (FR)

(21) Appl. No.: 19/218,754

(22) Filed: May 27, 2025

(30) Foreign Application Priority Data
Jun. 6, 2024 (FR) 2405945

(51) Int. Cl. F16C 33/58; F16C 19/16

(52) U.S. Cl. CPC F16C 33/586; F16C 19/16; F16C 2326/05

(57) ABSTRACT

A strut bearing device includes a lower support cover, an upper rest cover, and at least one bearing arranged between the lower and upper covers. The lower support cover includes an annular radial portion for supporting the bearing and an annular axial skirt which extends axially from the radial portion on the opposite side to the upper rest cover. The axial skirt has an annular inner surface provided with a plurality of stiffening ribs extending radially inwardly in a projecting manner and spaced in a circumferential direction.

### CROSS-REFERENCE

This application claims priority to French patent application no. 2405945 filed on Jun. 6, 2024, the contents of which are fully incorporated herein by reference.

### BACKGROUND OF THE INVENTION

The present invention relates to vehicle bearing devices, and more particularly to bearing devices used in the suspension strut rods of steered wheels of vehicles.

A strut bearing device generally comprises a rolling bearing forming an axial bearing, and upper and lower covers, which form a housing for the rings of the rolling bearing and make it possible to provide an interface between the rings and neighboring elements.

The strut bearing device is arranged in the upper part of the suspension strut between a suspension spring and an upper rest mount or seat which comes into contact with an element of the vehicle chassis. The suspension spring is mounted around a damping piston rod, the end of which is connected to the vehicle chassis. The helical-spring-type suspension spring rests axially in a direct or indirect manner on the lower cover of the strut bearing device.

The strut bearing device makes it possible to transmit axial and radial forces between the suspension spring and the vehicle chassis, while also allowing relative rotational movement between the lower cover and the upper cover resulting from the steered wheels of the vehicle being turned and/or the suspension spring being compressed.

### SUMMARY OF THE INVENTION

The present invention aims to reduce the costs of manufacturing known strut bearing devices.

The present invention relates to a strut bearing device comprising a lower support cover, an upper rest cover, and at least one bearing arranged between the covers, the lower support cover comprising an annular radial portion for supporting the bearing, and an annular axial skirt which extends axially from the radial portion on the opposite side to the upper rest cover. The axial skirt is provided with an annular inner surface.

According to a general feature, the annular inner surface of the axial skirt of the lower support cover is provided with a plurality of stiffening ribs which extend radially in a projecting manner and are spaced in the circumferential direction.

It is thus possible to reduce the radial thickness of the axial skirt of the lower support cover in comparison with a conventional lower support cover, while maintaining good mechanical resistance to the forces applied by the suspension spring, due to the presence of the stiffening ribs.

Advantageously, the lower support cover is made in one piece.

According to one embodiment, the stiffening ribs of the axial skirt of the lower support cover extend axially along the annular inner surface of the axial skirt.

Advantageously, the radial portion of the lower support cover comprises a plurality of reinforcing ribs spaced in the circumferential direction.

In this case, at least part of the stiffening ribs may be located in the continuation of one of the reinforcing ribs with respect to a radial direction.

According to one embodiment, the stiffening ribs of the lower support cover have different radial thicknesses. Alternatively, the stiffening ribs may have the same radial thickness.

Advantageously, the stiffening ribs of the lower support cover are spaced in a regular manner in the circumferential direction.

According to one embodiment, the axial skirt of the lower support cover comprises, at its free end, a collar extending radially towards the interior.

Advantageously, the stiffening ribs of the axial skirt of the lower support cover extend axially from the collar.

According to one embodiment, the collar has a radial thickness equal to or greater than the thickness of the stiffening ribs of the lower support cover.

### BRIEF DESCRIPTION OF THE SEVERAL VIEWS OF THE DRAWINGS

Other objects, features and advantages of the invention will become apparent upon reading the following description, given solely by way of non-limiting example, and with reference to the appended drawings, in which:

FIG. 1 is a perspective view of a strut bearing device according to a first exemplary embodiment of the invention;

FIG. 2 is an axial sectional view of the strut bearing device of FIG. 1;

FIG. 3A is a sectional view of the lower support cover of a strut bearing device according to a second exemplary embodiment of the invention;

FIG. 3B is a partial plan view of the lower support cover of the strut bearing device of FIG. 3A;

FIG. 4A is a sectional view of the lower support cover of a strut bearing device according to a third exemplary embodiment of the invention;

FIG. 4B is a partial plan view of the lower support cover of the strut bearing device of FIG. 4A; and

FIG. 4C is a partial perspective view of the lower support cover of the strut bearing device from FIGS. 4A and 4B.

### DETAILED DESCRIPTION OF THE INVENTION

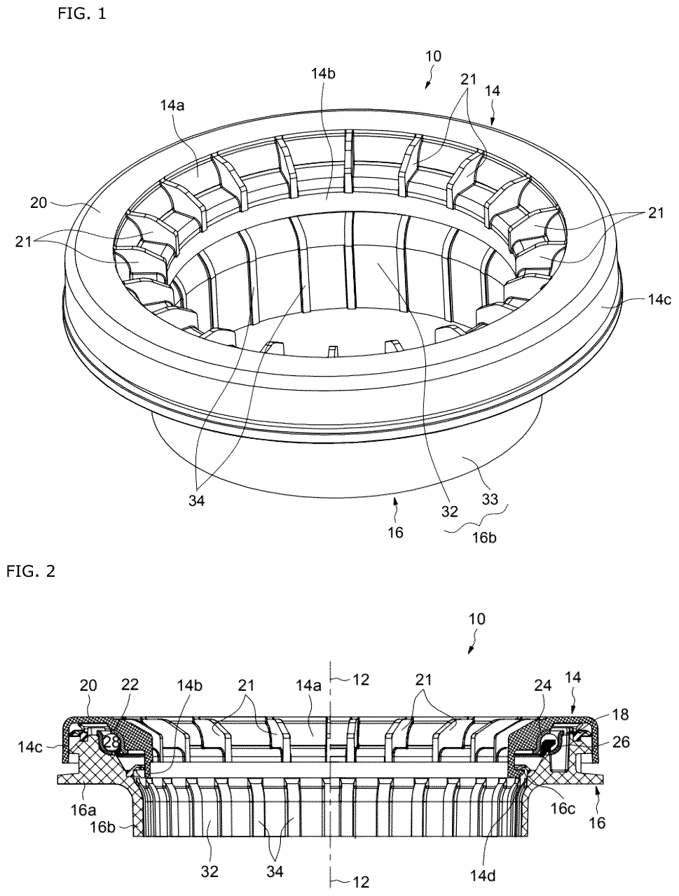

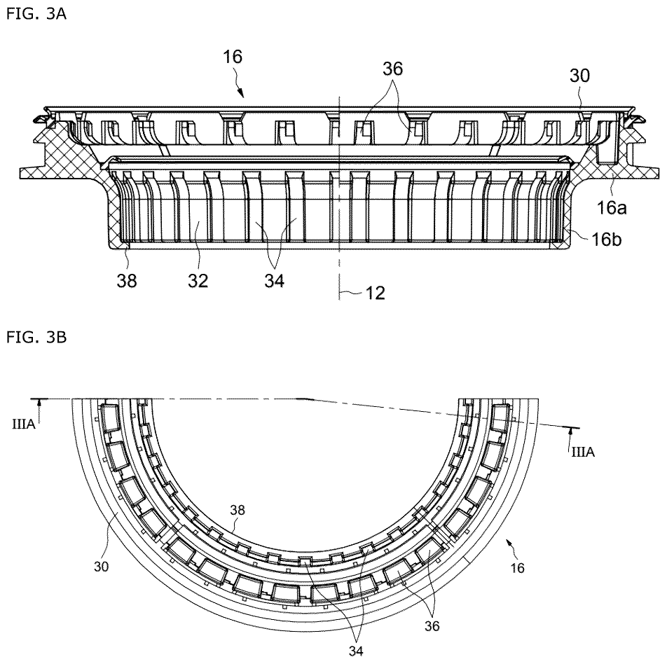

The strut bearing device 10 shown in FIGS. 1 and 2 is adapted for installation between an upper rest mount or seat (not shown), which comes into contact with a fixed chassis element of a motor vehicle, and a helical-type suspension spring (not shown). In FIGS. 1 and 2, the device 10 is shown in an assumed vertical position and has a vertical axis 12 extending through an axial center of the bearing device 10.

The device 10, with the axis 12, comprises an upper rest cover 14, a lower support cover 16 and an anti-friction bearing 18 interposed axially between the covers 14, 16. In the example illustrated, the covers 14, 16 are mounted in direct contact with the bearing 18, without the interposition of an intermediate element. Alternatively, the covers 14, 16 may be mounted in indirect contact with the bearing 18, with the interposition of an intermediate element (not shown).

The upper rest cover 14, with the axis 12, includes a radial portion 14a, an annular axial inner skirt 14b and an annular axial outer skirt 14c radially surrounding the inner skirt 14b. The radial portion 14a has an annular upper surface 20 intended to face the upper rest seat, and an opposing lower surface 22 in contact with the bearing 18. The upper surface 20 and lower surface 22 define the thickness of the radial portion 14a. In the example illustrated, the radial portion 14a has a tiered shape. The upper surface 20 forms the upper surface of the upper rest cover 14. The upper surface 20 is positioned axially on the opposite side to the lower support cover 16. The upper surface 20 is continuous in the circumferential direction.

The outer skirt 14c of the upper rest cover 14 partially surrounds the lower support cover 16 in a radial manner. The outer skirt 14c extends axially from the radial portion 14a.

The inner skirt 14b of the upper rest cover 14 extends within the interior of the hole of the lower support cover 16. The inner and outer skirts 14b, 14c extend axially downwardly from the radial portion 14a.

The upper rest cover 14 further comprises a plurality of inner hooks 14d, which are arranged on the inner skirt 14b and extend or project radially toward the exterior in the direction of the lower support cover 16. In the example illustrated, the hooks 14d are mutually spaced apart in the circumferential direction. Alternatively, it may be possible to provide a single annular hook (not shown).

According to the embodiment illustrated in the drawing figures, the upper rest cover 14 includes a plurality of stiffening ribs 21 extending toward the interior from the hole of the radial portion 14a, i.e., each stiffening rib 21 projects radially inwardly. The stiffening ribs 21 are mutually spaced apart in the circumferential direction. The upper end of each stiffening rib 21 is attached to the inner edge of the annular upper surface 20.

The bearing 18 is entirely located radially between the skirts 14b, 14c of the upper rest cover 14. The bearing 18 comprises an upper ring 24 in contact with the upper rest cover 14, a lower ring 26 in contact with the lower support cover 16, and a row of rolling elements 28, in this instance balls, arranged between the raceways formed on the rings 24, 26. In the example illustrated, the rolling bearing 18 is an angular-contact type rolling bearing. The upper ring 24 is in contact with the lower surface 22 of the radial portion 14a of the upper rest cover 14. The lower ring 26 is in contact with an upper surface 30 of the lower support cover 16.

The lower support cover 16 includes an annular radial portion 16a for supporting the bearing 18, the radial portion 16a being formed as a plate with which the lower ring 26 of the bearing 18 is in contact. The lower support cover 16 also includes an annular axial skirt 16b which extends axially from the radial portion 16a on the opposite side to the upper rest cover 14 and the bearing 18. The skirt 16b enables centering of the suspension spring (not shown).

The lower support cover 16 includes an inner annular hook 16c arranged in the inner radial continuation of the radial portion 16a at the junction of the radial portion 16a with the axial skirt 16b. Alternatively, it may be possible to provide a plurality of inner hooks 16c.

The inner hook 16c extend radially toward the interior in the direction of the upper rest cover 14. The hook 16c is adapted for mating diametrically with the inner hooks 14d of the upper rest cover 14. The hooks 16c, 14c form a retaining means which axially retains the upper rest cover 14 and the lower support cover 16 relative to each other.

The lower support cover 16 is made in one piece, i.e., is of one-piece construction. Specifically, it may consist of a single piece, for example made of a plastic material, such as polyamide PA 6.6, which may or may not be reinforced with glass fibers.

The axial skirt 16b of the lower support cover 16 is provided with an annular inner surface 32 and an annular outer surface 33 radially opposing the annular inner surface 32. The annular inner surface 32 and the annular outer surface 33 delimit the radial thickness of the axial skirt 16b. The annular outer surface 33 forms a surface for radially centering the suspension spring.

The annular inner surface 32 of the axial skirt 16b of the lower support cover 16 is provided with a plurality of stiffening ribs 34 which extend radially in a projecting manner and are mutually spaced in the circumferential direction. The stiffening ribs 34 are in this instance spaced in a regular or even manner in the circumferential direction. Alternatively, the circumferential spacing between the stiffening ribs 34 could be irregular or staggered apart.

The thickness of the annular axial skirt 16b of the lower support cover 16 may thus be decreased or reduced in comparison with the thickness of conventional lower support covers, thus making it possible to reduce or lower the costs of manufacturing the strut bearing device 10. The stiffening ribs 34 enables reinforcement of the annular axial skirt 16b.

The stiffening ribs 34 of the axial skirt 16b of the lower support cover 16 extend axially along the annular inner surface 32 of the axial skirt 16b. In this instance, each stiffening rib 34 extends axially over the entire annular inner surface 32, from the radial portion 16a to the end of the annular inner portion 32. The end of each stiffening rib 34 at the radial portion 16a has a fillet which makes it possible to fit closely with the curvature of the axial skirt 16b at the junction between the axial skirt 16b and the radial portion 16a. Alternatively, the stiffening ribs 34 could have reduced axial dimensions.

In the embodiment illustrated in the drawing figures, the radial portion 16a of the lower support cover 16 is provided with a plurality of reinforcing ribs 36 which are spaced apart in the circumferential direction, in this instance in a regular or even manner. The stiffening ribs 34 of the axial skirt 16b are preferably located in the continuation of the reinforcing ribs 36 of the radial portion 16a with respect to a radial direction.

Alternatively, the stiffening ribs 34 of the axial skirt 16b of the lower support cover 16 and/or the reinforcing ribs 36 of the radial portion 16a of the lower support cover 16 may have different radial thicknesses. It is possible that all or some of the stiffening ribs 34 are not located in the continuation of the reinforcing ribs 36 of the radial portion 16a.

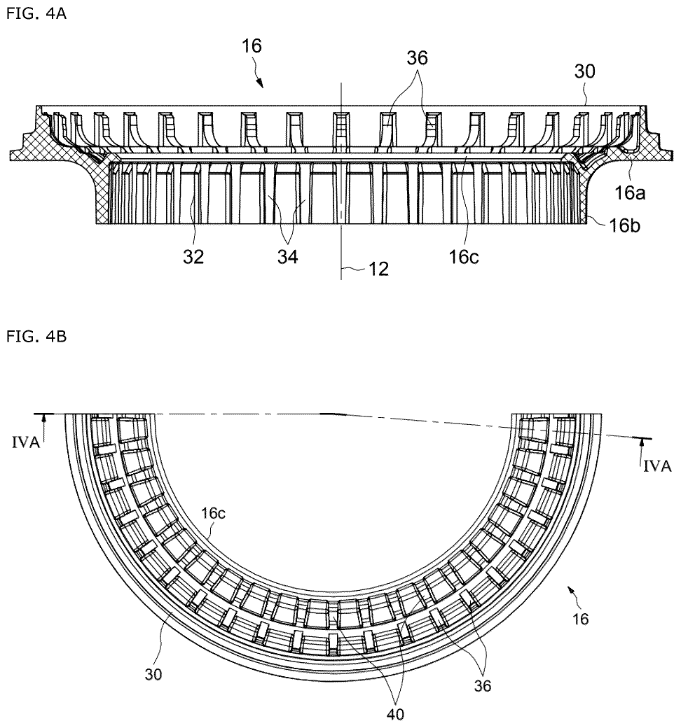

FIGS. 3A and 3B show a second embodiment of the strut bearing device 10. The axial skirt 16b of the lower support cover 16 includes, at a free end of the skirt 16b, a radial collar 38 extending radially toward the interior. In particular, the collar 38 radially continues the annular inner surface 32 toward the interior of the device 10. The stiffening ribs 34 of the axial skirt 16b of the lower support cover 16 extend axially from the radial collar 38 to the radial portion 16a of the lower support cover 16. The radial collar 38 has a radial thickness greater than the radial thickness of the stiffening ribs 34 of the lower support cover 16.

Alternatively, the collar 38 could have a radial thickness equal to the radial thickness of the stiffening ribs 34, thus creating a smooth surface between the collar 38 and the stiffening ribs 34.

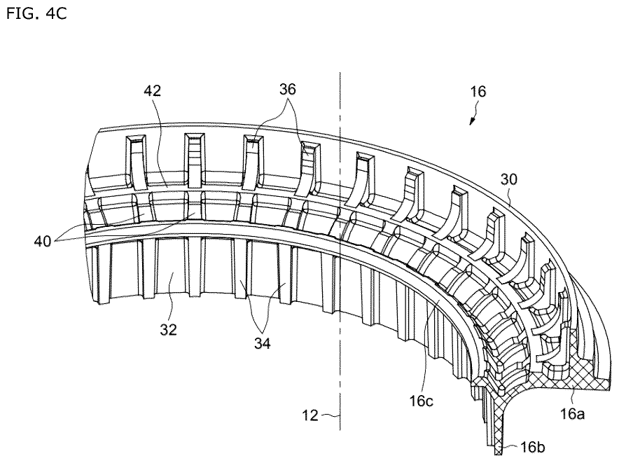

FIGS. 4A, 4B and 4C depict a third embodiment of the strut bearing device 10.

As illustrated in FIG. 4C, the radial portion 16a of the lower support cover 16 includes a first, upper tier in which the reinforcing ribs 36 are disposed and a second, lower tier including reinforcing ribs 40, the two tiers being separated by an annular radial platform 42. The second tier extends between the annular radial platform 42 and the annular hook 16c with respect to a radial direction.

The reinforcing ribs 40 are spaced in the circumferential direction, in this instance in a regular or even manner. The stiffening ribs 34 of the axial skirt 16b are preferably located in the continuation of the reinforcing ribs 40 of the radial portion 16a with respect to a radial direction. Alternatively, it is possible that the stiffening ribs 34 are not located in the continuation of the reinforcing ribs 40 of the radial portion 16a. Similarly, the reinforcing ribs 40 are located in the continuation of the reinforcing ribs 36 of the first, upper tier of the axial portion 16a.

In the depicted embodiment, the stiffening ribs 34 extend axially over the entire annular inner surface 32, from the radial portion 16a to the end of the annular inner surface 32. The surface of the stiffening ribs 34 is planar and fits closely with the straight shape of the axial skirt 16b. Alternatively, the stiffening ribs 34 could have reduced axial dimensions.

According to this third embodiment, the axial skirt 16b of the lower support cover 16 does not include a radial collar 38, the end of the annular inner surface 32 of the axial skirt 16b only extending axially. The end of the stiffening ribs 34 is aligned with the end of the annular inner surface 32 of the axial skirt 16b. Alternatively, the axial skirt 16b according to this third embodiment may include a radial collar.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A strut bearing device comprising:
a lower support cover;
an upper rest cover; and
at least one bearing arranged between the lower support cover and the upper rest cover;
wherein the lower support cover includes an annular radial portion configured to support the bearing and an annular axial skirt extending axially from the radial portion on an opposite side to the upper rest cover, the axial skirt having an annular inner surface provided with a plurality of stiffening ribs which each project radially inwardly, the plurality of ribs being spaced apart in a circumferential direction.

2. The device according to claim 1, wherein the lower support cover is of one piece construction.

3. The device according to claim 1, wherein the stiffening ribs of the axial skirt of the lower support cover extend axially along the annular inner surface of the axial skirt.

4. The device according to claim 1, wherein the radial portion of the lower support cover includes a plurality of reinforcing ribs spaced apart in the circumferential direction, each one of at least a portion of the plurality of the stiffening ribs of the axial skirt being located in radial continuation of a separate one of the plurality of reinforcing ribs.

5. The device according to claim 1, wherein the plurality of stiffening ribs of the axial skirt of the lower support cover have different radial thicknesses.

6. The device according to claim 1, wherein the plurality of stiffening ribs of the axial skirt of the lower support cover are evenly spaced in the circumferential direction.

7. The device according to claim 1, wherein the axial skirt of the lower support cover has a free end and includes a collar located at the free end, the collar extending radially toward the interior.

8. The device according to claim 7, wherein the stiffening ribs of the axial skirt of the lower support cover extend axially from the collar.

9. The device according to claim 7, wherein the collar has a radial thickness equal to or greater than a thickness of each of the stiffening ribs of the lower support cover.
